(19) United States
(12) Patent Application Publication
(10) Pub. No.: US 2008/0043031 A1
(43) Pub. Date: Feb. 21, 2008

(54) Picture adjustment methods and apparatus for image display device

(75) Inventor: Adil I. Jagmag, Nashua, NH (US)

Correspondence Address: GUERIN & RODRIGUEZ, LLP, 5 MT. ROYAL AVENUE, MARLBOROUGH, MA, 01752, US

(73) Assignee: ATI Technologies, Inc., Markham (CA)

(21) Appl. No.: 11/504,496

(22) Filed: Aug. 15, 2006

(51) Int. Cl. G09G 5/00

(52) U.S. Cl. 345/581

(57) ABSTRACT

Described are methods, devices, and systems for optimizing presentation of an image-bearing signal on a display device equipped with at least one adjustable picture control variable. The methods utilize, and the devices include, a picture control setting generator for determining different picture control settings, and an on-screen display generator for producing an on-screen display including multiple image cells (e.g., a mosaic). Each cell displays the same received image-bearing signal tuned according to a respective one of the different picture control settings. An end user selects among the different cells, choosing a cell that provides a preferred picture quality. In some embodiments, the picture control setting generator determines new picture control settings in response to the selected cell. Again, the on-screen display generator produces an on-screen display including multiple cells according to the new picture control settings, with the end user selecting one of the cells providing a preferred picture quality.

### FIELD OF THE INVENTION

The invention relates generally to image displays. More particularly, the invention relates to selecting picture control settings for reproducing on a display device images having a preferred quality.

### BACKGROUND

Display devices that reproduce images, such as video images for viewing typically include one or more picture parameters or control variables that can be adjusted to affect the quality of the displayed video image. Exemplary display devices include computer monitors, studio video monitors, and television sets. Some exemplary picture control variables include brightness, saturation, color, and hue. Picture quality depends at least in part upon ambient light conditions as well as user preferences. Video monitors, for example, typically include controls for both brightness and contrast that can be adjusted to control quality of the displayed video image. Such variability allows an end user to configure the video monitor for optimal viewing within a given environment.

TV sets, for example, often provide users with several individually adjustable picture control variables that can include: saturation; color; and picture or sharpness. Unfortunately, adjusting the picture control variables for a given display device can be a deceivingly complicated task that produces uncertain and even conflicting results. For example, the brightness and contrast labels ascribed to the video monitor control variables can be misleading with respect to their functions. Namely, the brightness control variable primarily affects reproduced contrast (i.e., black level); whereas, the contrast control variable primarily affects only brightness (i.e., white level). Setting the brightness control variable too high results in blacks being displayed as grays. Proper adjustment of the brightness control variable ensures that black video image content displays as true black on the video monitor. Improper adjustment of this control variable is a common problem resulting in poor quality picture on computer monitors, video monitors, and television sets. Such misleading labels have led to a great deal of confusion about how to set up a monitor for good video image display.

Available picture control variables may vary from device to device, depending upon the manufacturer. Additionally, the labels attributed to these picture control variables can lead to confusion on the part of the end user, since there are no generally accepted standards for the labeling of picture control variables. Thus, picture control variables that adjust the same picture parameter on different display devices can include different labels (e.g., “tint” on one set may be labeled “hue” on another, or “brightness” may also be labeled “picture”).

To further complicate matters, adjustment of one of the picture control variables may negate the desired effects of a previously adjusted control variable. This unfortunate result is due to interrelation or interplay between two or more of the adjustable picture control variables. For example, brightness and contrast can be to some degree interactive. Thus, a new contrast setting may alter a previously established brightness level. Proper settings of the two picture control variables may involve back-and-forth adjustments of each of the controls until an optimum viewable image quality is obtained. As a result, the picture-adjustment process can be a frustrating experience to the end user as each adjustment of the different picture control variables produces uncertain and unpredictable results. Frequently, the end user is often left with a non-optimal setting of the picture control variables.

Resources are available to guide an end user through a detailed setup procedure (see for example “FAQ: How to Adjust a TV” available on the Internet at http://myweb.accessus.net/˜090/how2adj.html). These procedures provide a so-called “eyeball” calibration designed to obtain a viewable image approximating a standard, such as the National Television Systems Committee (NTSC) standard. As such, these procedures may not satisfy the taste of any given end user, particularly as the picture controls interplay with the colors and lighting of the surrounding environment. Additionally, such calibration procedures may call for one or more standard test patterns that must be obtained separately (i.e., purchased) and used in combination with the procedure.

### SUMMARY

What is needed is a simplified process that guides an end user through configuration of the adjustable picture control variables resulting in a preferred or optimal picture rendition of a displayed image for one or more of a given environment, program genre, and user preference. Beneficially, the present invention is directed towards methods, devices, and systems for optimizing presentation of an image on a display device providing adjustable picture control variables.

In one aspect, the invention features a picture-adjustment process for optimizing presentation of an image-bearing signal on a display device having at least one adjustable picture control variable. The process includes receiving an image-bearing signal, determining a first group of picture control settings, each representing a different configuration of the at least one adjustable picture control variable, and generating an on-screen display image having multiple pictures or image cells. Each of the image cells is similar in appearance to a picture-in-picture image in that the image cell displays a representation of the received image-bearing signal using a respective one of the first group of picture control settings. The multiple image cells of the first on-screen display allow an end user to observe results of the different picture control settings upon the same image. The image cells can be arranged in a side-by-side manner, such as in a grid. More generally, the multiple image cells are displayed in a mosaic pattern. The end user simply selects a preferred one of the multiple different image cells. Upon accepting the user selection, the process includes adjusting the at least one adjustable picture control variable to the picture control setting of the preferred one of the plurality of image cells.

In some embodiments, the process includes further determining another group of picture control settings in response to the previous end-user selection. Once again, the end user is presented with an on-screen display image having multiple pictures or image cells, each image cell displaying a representation of the received image-bearing signal using a respective one of the second group of picture control settings. Once again, the end user simply selects a preferred one of the multiple image cells. The process can be repeated again and again, with the different picture control settings being derived by one or more algorithms. Upon completion of the picture adjustment process, the final selected picture control settings are applied to the display device as a new preset setting of the at least one picture control variable.

In another aspect, the invention features a device for optimizing presentation of an image-bearing signal on a display device equipped with at least one adjustable picture control variable. The device includes a memory configured to store at least one of several groups of picture control settings and a processor in communication with the memory and configured to receive the image-bearing signal. The processor includes a picture control setting generator configured to determine a first group of picture control settings, each representing a different configuration of the at least one adjustable picture control variables. The processor also includes an on-screen display generator configured to generate a first on-screen display including multiple picture or image cells, with each image cell displaying a representation of the received image-bearing signal using a respective one of the first group of picture control settings. A display device in communication with the processor provides an end user with a visual representation of the first on-screen display. In some embodiments, the device also includes a user interface in communication with the processor configured to accept an end user selection of a preferred one of the multiple image cells, indicative of a preferred picture control setting.

In another aspect, the invention features a device for optimizing presentation of an image-bearing signal on a display device equipped with at least one adjustable picture control variable. The device includes means for receiving the image-bearing signal, means for automatically determining a group of picture control settings, each representing a different configuration of the at least one adjustable picture control variable, and means for generating an on-screen display image including multiple image cells. Each image cell displays a representation of the received image-bearing signal using a respective one of the group of picture control settings. The device also includes means for accepting an end user selection of a preferred one of the multiple image cells.

In yet another, the invention features a picture-adjustment process for optimizing presentation of an image-bearing signal on a display device having at least one adjustable picture control variable. The process includes receiving a sensor signal, determining a first group of picture control settings responsive at least in part to the received sensor signal and generating a first on-screen display image having multiple pictures or image cells. Each of the first group of picture control settings represents a different configuration of the at least one adjustable picture control variable. Each of the image cells is similar in appearance to a picture-in-picture image in that the image cell displays a representation of the received image-bearing signal using a respective one of the first group of picture control settings. The multiple image cells of the first on-screen display allow an end user to observe results of the different picture control settings upon the same image. The image cells can be arranged in a side-by-side manner, such as in a grid. More generally, the multiple image cells are displayed in a mosaic pattern. The end user simply selects a preferred one of the multiple different image cells.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a schematic block diagram of an exemplary image display device.

FIG. 2A is a schematic block diagram of an embodiment of a video display device having a picture-adjust module.

FIG. 2B is a schematic block diagram of an alternative embodiment of a video display device having a picture-adjust module.

FIG. 3A is a more-detailed schematic block diagram of one embodiment the picture-adjust module of FIG. 2A.

FIG. 3B is a more-detailed schematic block diagram of another embodiment of the picture-adjust module of FIG. 2B.

FIG. 4 is a flow diagram illustrating the steps of one embodiment of the invention.

FIG. 5A is a graphical representation of one embodiment of an exemplary output image.

FIG. 5B is a graphical representation of an embodiment of a different exemplary output image.

FIG. 6 is a schematic illustration of interrelated output images.

### DETAILED DESCRIPTION

A description of preferred embodiments of the invention follows.

The process of adjusting the one or more “picture control variables” of a video display device for an optimal or preferred viewable image quality is accomplished by automatically generating several different picture control settings, applying the different picture control settings to a received video image, and producing an on-screen display image including multiple picture or image cells, each cell including a rendition or picture of the same received video image. A picture control setting refers to one configuration or instance of the one or more adjustable picture parameters or control variables tuned differently. A first exemplary picture control setting for a display device providing two adjustable picture control variables, such as brightness and contrast can be represented as (brightness=50%, contrast=50%). A second, different exemplary picture control setting for the same display device is (brightness=75%, contrast=50%).

Beneficially, each image cell depicts the received video image adjusted differently according to a respective one of the different picture control settings. Presentation of the on-screen display image with its multiple image cells facilitates adjustment of the picture control settings by presenting an end user with a means for comparing the effects of different picture control settings on the same received video image. The end user simply selects one of the image cells of the on-screen display image representing a preferred one of the different picture control settings. The different image cells can be arranged in a side-by-side manner, in an array, such as a rectangular grid, or more generally in a regular or even an arbitrary mosaic pattern.

The process can be repeated using a new group of picture control settings determined, at least in part, in response to the previous cell selection. In some embodiments, generation of the different picture control settings is accomplished using a convergent algorithm. Accordingly, subsequently generated groups of different picture control settings approximate an end user's preferred viewable video image as determined by the end user's previous selections. At some point, the end user enters a final selection and the picture control settings associated with the final selection are applied to the display device as either temporary or new default settings of the adjustable picture control variables.

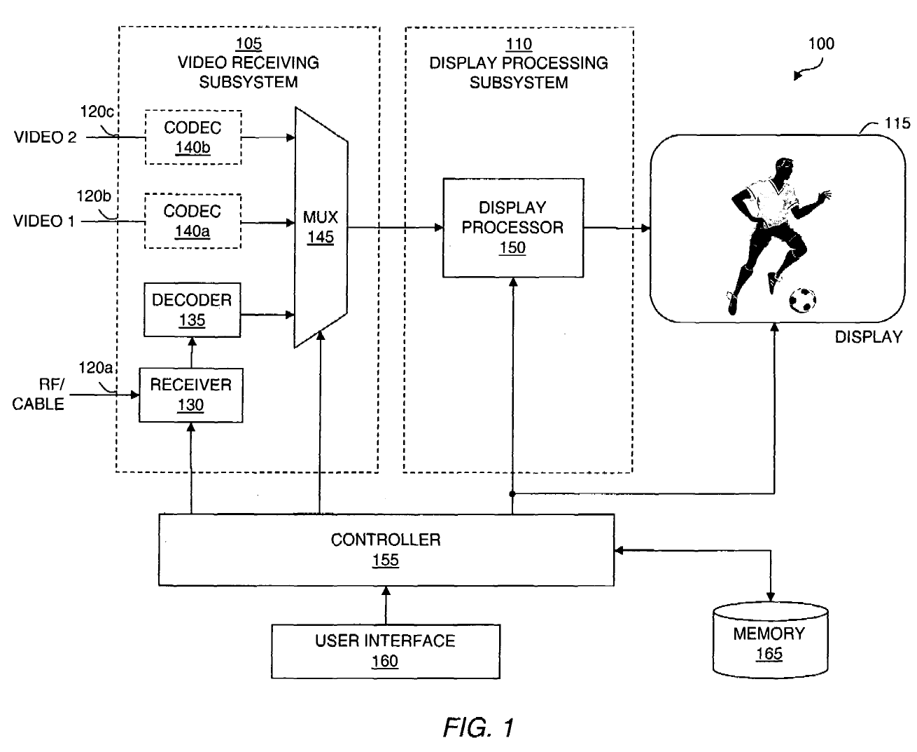

FIG. 1 shows a functional block diagram of an exemplary video display device 100 in the form of a television (TV) receiver, referred to herein as a TV set 100. The TV set 100 includes a video receiving subsystem 105 for receiving a video signal, and a display processing subsystem 110 for processing image content of the received video signal for display. A video display screen 115 provides a visual representation or picture of the image content of the received video image. The TV set 100 also includes a user interface 160 for accepting user input and a controller 155 for controlling operation of the TV set 100 in response to user input received via the user interface 160.

In more detail, the video receiving subsystem 105 includes one or more physical input ports 120a, 120b, 120c (generally 120), each adapted to receive a respective input signal. For the exemplary TV set 100, one of the input ports is adapted to receive TV broadcast signals. TV broadcast signals can be received over one or more different media, including terrestrial TV broadcasts, cable broadcasts, and satellite broadcasts. Other input ports 120b, 120c are adapted to receive external audio/visual input signals from one or more external video sources. Some exemplary external sources include digital video disc (DVD) players (sometimes referred to as digital versatile disc), computers, and game consoles.

Each of the input ports 120 includes a physical interface that generally conforms to one of a number of available standard video interfaces. Some exemplary video interfaces include Digital Video Interface (DVI); High-Definition Multi-media Interface (HDMI); component video; “Separate” Video (referred to as S-Video); and SCART (French-originated standard and associated 21-pin connector for connecting audio and video equipment to television sets).

DVI refers to a standard interface between digital devices such as projectors and personal computers. A DVI interface is primarily a digital interface that may be all-digital, or a digital with an analog component. Accordingly, a DVI-compliant interface accommodates high-bandwidth video, carrying digitized RGB picture information. HDMI is an all-digital, standard high-speed serial interface capable of carrying video, audio, data and control signals. An HDMI-compliant interface accommodates standard, enhanced, or high-definition video.

A composite video interface includes one signal providing all of the video information. An S-Video (sometimes referred to as Y/C video) interface includes two separate video signals: one signal providing brightness (luminance) information, the other signal providing color (chroma) information. A component video interface includes three video signals: one signal providing brightness information, the two other signals providing color information.

SCART is primarily a European standard using a 21 pin interface to carry two audio in and out channels, in and out video channels, RGB signals, ground and some additional control signals. A SCART interface may accommodate one video signal (e.g., composite video), two video signals (e.g., S-Video), three signals of separate red, green and blue or RGB (for picture quality similar to component video), and for best picture quality, four video signals of separate red, green, blue and sync or RGBS. Other signals include right and left line-level audio channels and a number of control signals including an aspect-ratio flag (e.g., widescreen).

The video receiving subsystem 105 includes an RF receiver 130 coupled to the RF input port 120a. The RF input port 120a includes a radio-frequency (RF) coaxial input, suitable for interconnecting to either an antenna or a cable source. The RF input port 120a receives the entire TV broadcast spectrum, or at least a portion thereof. The TV broadcast spectrum includes several different channels, each providing respective audio-visual content. The audio-visual content is impressed (i.e., modulated) upon a respective RF carrier signal associated with each of the different channels.

The RF receiver 130 includes a tuner for selecting a desired channel and a demodulator for extracting audio-visual content information from the selected channel. The extracted signal includes a composite video signal, that conforms to one of the available broadcast standards including the NTSC standard for analog transmissions within the United States, the Phase Alternation Line (PAL) standard for analog transmissions within Europe and other parts of the World outside of the United States, and the Sequential Couleur Avec Memorie (SECAM) standard for analog transmissions in France and Eastern European countries.

The output of the RF receiver 130 includes a composite video signal. A decoder 135 is provided to break down the composite video signal into its components for further processing by the display processing subsystem 110. For example, an NTSC decoder breaks down the NTSC video formatted signal to obtain three component signals: a black-and-white component signal and two color component signals.

It is worth noting that the audio signal is typically received together with the video signal from which it can be demultiplexed for separate processing. As the invention relates to video processing, audio signal processing is not described further herein.

In some embodiments the demodulated audio-visual signal is a digital signal (i.e., digital television). For example, digital TV signals are used in the broadcast of high-definition television (HDTV) to provide a higher-quality resolution than available using traditional formats (e.g., NTSC, PAL, and SECAM). The digital video data stream, for example, can include digitized RGB signals or digitized YUV signals. Digital TV broadcasts typically use a form of compression, such as the MPEG-2 compression algorithm. Accordingly, the TV set 100 includes a compressor/decompressor (codec) for decompressing previously compressed digital data.

In some embodiments, one or more of the external video input ports 120b, 120c includes a respective codec 140a, 140b (generally 140), each adapted to convert an MPEG-2 encoded data stream into an unencoded digital video data stream. The codecs 140 are shown in phantom to reflect that in some embodiments, the codec function is non necessary as it can be performed within an external device, such that the TV set 100 received a decompressed digital video signal. Exemplary external devices include cable boxes and satellite receivers (referred to generally as “set-top boxes”). Although two codecs 140 are shown, in some embodiments a single codec 140 can be shared among two or more of the video input ports 120. The codecs 140 can be implemented in software, hardware, or a combination of both software and hardware.

The video receiving subsystem 105 also includes a multiplexer (MUX) 145 used to select one of the input ports 120 for further processing and display. Depending upon a control input received from the controller 155, the MUX 145 interconnects a video signal from the selected input port 120 to the display processing subsystem 110. The display processing subsystem 110, in turn, includes a display processor 150 that converts the received video signal to an image output signal. The image output signal is ultimately forwarded to the video display screen 115 for viewing.

In more detail, the display processor 150 processes video images by performing conversions to a signal format appropriate for displaying video images on the display screen 115. These conversions can include one or more of color-space conversions (e.g., from RGB to YUV), format conversions (e.g., from non-interlaced to interlaced frame sequences), and pixel stream encoding to one of the standard formats (e.g., NTSC, PAL and SECAM). For example, when receiving an NTSC video signal, the display processor 150 extracts the black-and-white signal information and information from the two color signals and converts them, as required, to another video format, such as RGB format to drive the display screen 115. For an RGB example, the image output signal includes three separate component signals: red, green, and blue, each used to drive individual pixels of a suitably formatted display screen 115.

The display screen 115 converts the electrical image output signal received from the display processing subsystem 110 into visible light, typically in the form of an array of picture elements, or pixels. The display screen 115 is shown displaying an exemplary received black-and-white video image. The display screen 115 can include any of a number of available technologies. Presently-available technologies include: cathode ray tubes (CRT), projection screens, and flat-panel screens. The flat panel screens, in turn, can be further subdivided into liquid crystal display (LCD) devices and plasma devices.

The user interface 160 typically includes front-panel controls provided on the TV set 100 as well as remote control devices, such as the ubiquitous infrared (IR) remote control. The controller 155 receives user input from the user interface 160 and, in response, provides the appropriate control signals to the TV set 100. For example, the controller 155 provides tuning commands to the RF receiver 130 in response to user selection of a particular channel. The tuning commands instruct a tuner within the RF receiver 130 to select a desired content channel from the received TV broadcast signal. The controller 155 also provides a source-selection control to the MUX 145 in response to user selection of one of the available video sources. The source-selection control configures the MUX 145 to interconnect the selected video input port 120 to the display processing subsystem 110.

The controller 155 is also coupled to the display processing subsystem 110 and optionally to the display screen 115 to adjust the one or more picture control variables thereby tuning visual display of the video images. These adjustable picture control variables include picture parameters provided by the manufacturer. Most TV sets 100 and video monitors provide some level of adjustment for picture control variables that can be manipulated through the user interface 160. For example, many standard picture control variables include: brightness, contrast, color, tint, and sharpness. Adjusted values for each of the one or more picture control variables, referred to herein collectively as a picture control setting, are provided to the display processor 150, which processes the received video signal according to the picture control setting.

Additional adjustable picture control variables can be provided to the display screen 115, such as an adjustable intensity variable for the light engines. Light engines of a CRT display include the electron guns; whereas, light engines of an LCD display refer to its backlight source. In some embodiments, a picture control setting is stored in a memory 165 and read by the display processor 150 upon system power on. In other embodiments, the display processing subsystem 110 includes memory for storing the picture control setting locally. In some embodiments, multiple different picture control settings can be stored in the memory as selectable presets. For example, a chosen preset is loaded into the display processor 150 upon user selection. Thus, selection of a single preset adjusts one or more of the adjustable picture control variables to a desired value according to the previously-stored picture control setting. Such presets can be pre-programmed by a manufacturer, with each preset optimized for a respective category of program, such as sports or movies.

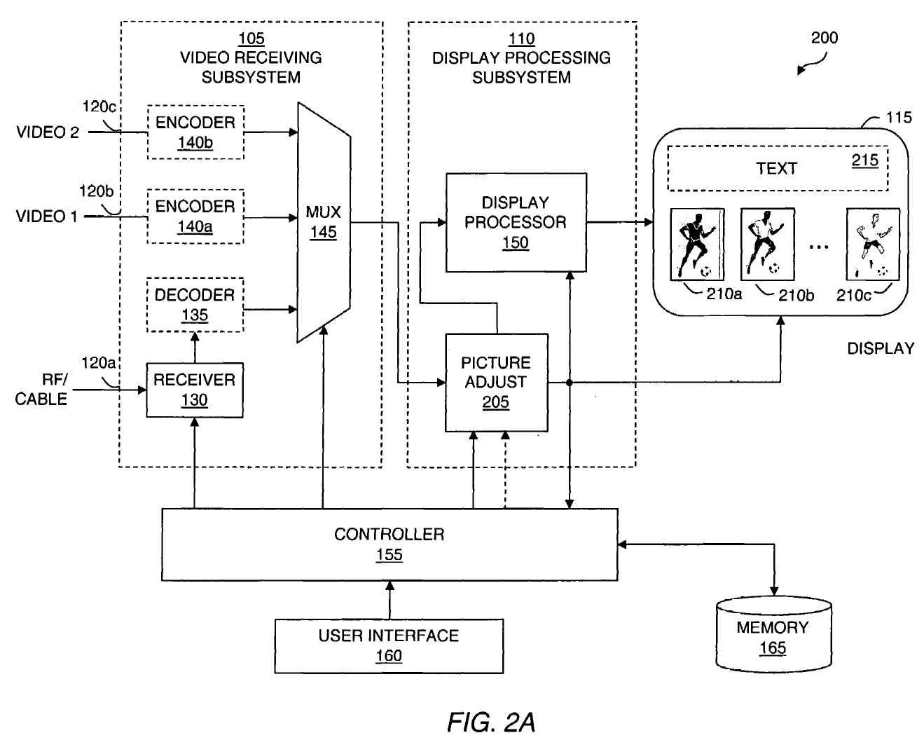

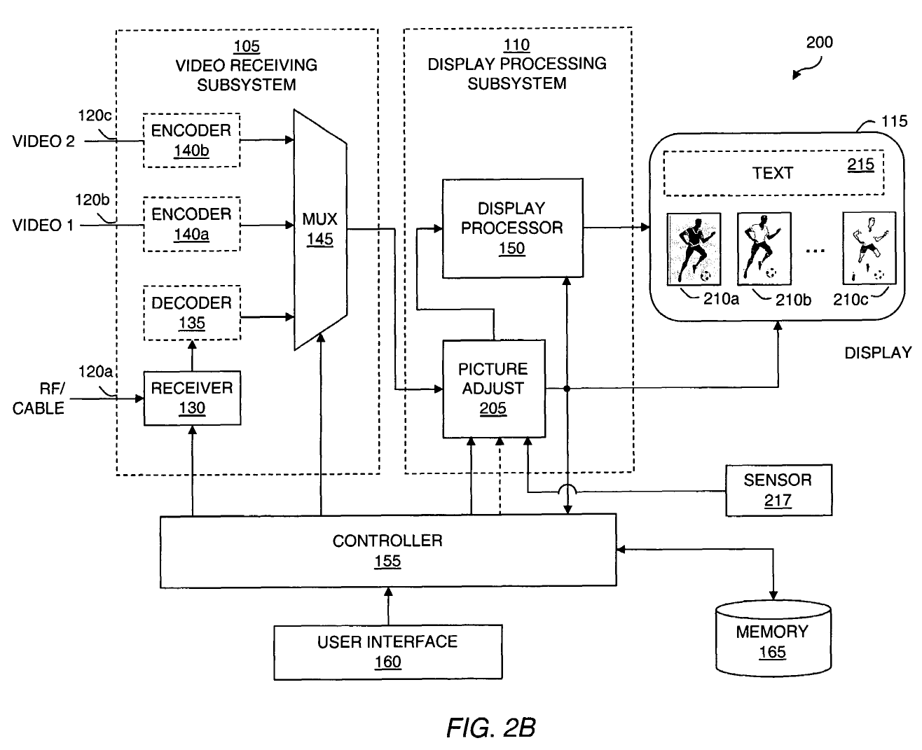

FIG. 2A shows a schematic block diagram of an embodiment of a TV set 200 constructed in accordance with the invention, in which the display processing subsystem 110 includes a picture-adjust module 205. The picture-adjust module 205 is coupled between the output of the video receiving subsystem 105 and the input of the display processor 150. The picture-adjust module 205 is also coupled to the controller 155. The TV set 200 is adjustable between at least two operational modes: a normal viewing mode and a display-setting mode. The normal viewing mode displays the received video image with the one or more adjustable picture control variables adjusted according to the current picture control setting (i.e., the selected preset). The display-setting mode can be initiated in response to an end user command. Once initiated, the display-setting mode presents the user with one or more on-screen displays that can be manipulated by the end user to adjust any or all of the one or more adjustable picture control variables.

In some embodiments, the picture-adjust module 205 routes the received video through to the display processor 150 in normal viewing mode. In other embodiments, the received video signal bypasses the picture adjust-module 205 during normal viewing mode.

In the display-setting mode, the TV set 200 initiates a picture-adjust procedure in which a group of different picture control settings are generated, each group varying at least one different value of the adjustable picture control variables. The picture-adjust module 205 generates the group of different picture control settings. The picture-adjust procedure is typically performed as part of a setup procedure, but can be initiated at any time. Selecting operation between the two different modes can be accomplished through the user interface 160.

During the picture-adjust procedure, the picture-adjust module 205 generates an on-screen display image including multiple image cells, with each image cell including a representation of the received video image tuned differently using a respective one of the group of different picture control settings. The display processor 150 receives the on-screen display image for processing and presentation on the display screen 115. The display screen 115 is illustrated displaying an on-screen display image having several image cells 210a, 210b, 210c (generally 210), each including a different representation of the received video image of FIG. 1 with a different respective picture control setting. Also shown is an optional field 215 that can include instructional text and/or graphics information for guiding an end user through the picture-adjust procedure as described in more detail below.

The picture-adjust module 205 generates the different picture control settings in response to a control signal received from the controller 155 indicating entry into a display-setting mode of operation. Selections of a preferred image 210 can be accomplished by the end user through the user interface 160, with the user selection reported by the controller 155 to the picture-adjust module 205. The picture-adjust module 205 forwards the picture control setting associated with a final selected image cell to the display processor 150 and the display screen 115 for persistent use during a normal viewing mode of operation. Thus, all subsequent video images received after exiting the display-setting mode are displayed with the final selected picture control setting. Alternatively, or in addition, the picture-adjust module 205 forwards the final picture control setting to the memory 165 for storage.

The picture-adjust module 205 can be implemented in hardware, in software, and using combinations of both hardware and software. Although illustrated and described as being provided within the display processing subsystem 110, the picture-adjust module 205 can be provided within the video receiving subsystem 105, within the controller 155, or as a separate, standalone module.

FIG. 2B shows a schematic block diagram of an alternative embodiment of a TV set 200 constructed in accordance with the invention, in which the picture adjust module 205 receives an input signal from a sensor 217. The sensor 217 provides an input to the picture adjust module 205 that can be used in the generation of different picture control settings. Thus, the generated picture control settings depend, at least in part, on the received input from the sensor 217.

In one embodiment, the sensor 217 includes a light sensor providing to the picture adjust module 205 an input signal indicative of the ambient lighting in the local environment in which the display 115 is placed. For example, the light sensor 217 includes a photo-detector, such as a photo-transistor or photodiode supplying an electrical current proportional to the ambient lighting. The picture adjust module 205 uses the received input signal to tailor generation of the different picture control settings to the ambient lighting conditions.

When the ambient lighting is low, as in a darkened room, the picture adjust module 205 generates different picture control settings to produce enhanced viewing in a darkened room. For example, the picture adjust module 205 generates different picture control settings having different respective values of reduced brightness in response to a sensor input indicative of a darkened room. The same picture adjust module 205 generates picture control settings having various different values of increased brightness in response to a sensor input signal indicative of a bright room (e.g., daylight).

In another embodiment, the sensor 217 is a temperature sensor providing to the picture adjust module 205 an input signal indicative of an ambient temperature. The ambient temperature of the room can also be used by the picture adjust module 205 to tailor the different picture control settings to the ambient temperature conditions. Whether the ambient temperature is low or high, the picture adjust module 205 generates different picture control settings to produce enhanced viewing in a cool room, or in a warm room, as the case may be. For example, picture control settings having a warmer color palette are generated for cooler ambient temperatures; whereas, picture control settings having a cooler color palette are generated for warmer ambient temperatures.

In yet other embodiments, the sensor is a mood sensor. The mood sensor can be provided through the user interface 160. Thus, an end user can enter a current mood, or select a mood from a list of different moods (e.g., Relaxed, Angry, and Melancholy). The picture adjust module 205 receives the identified mood and generates different picture control settings to produced enhanced viewing for the identified mood. For example, upon sensing a melancholy mood, the picture adjust module 205 generates different picture control settings that are brighter and have more intense color in an attempt to offset the viewer's melancholia. In another example, upon sensing an angry mood, the picture adjust module 205 generates different picture control settings that are softer with less intense colors in an attempt to provide a calming effect upon the viewer.

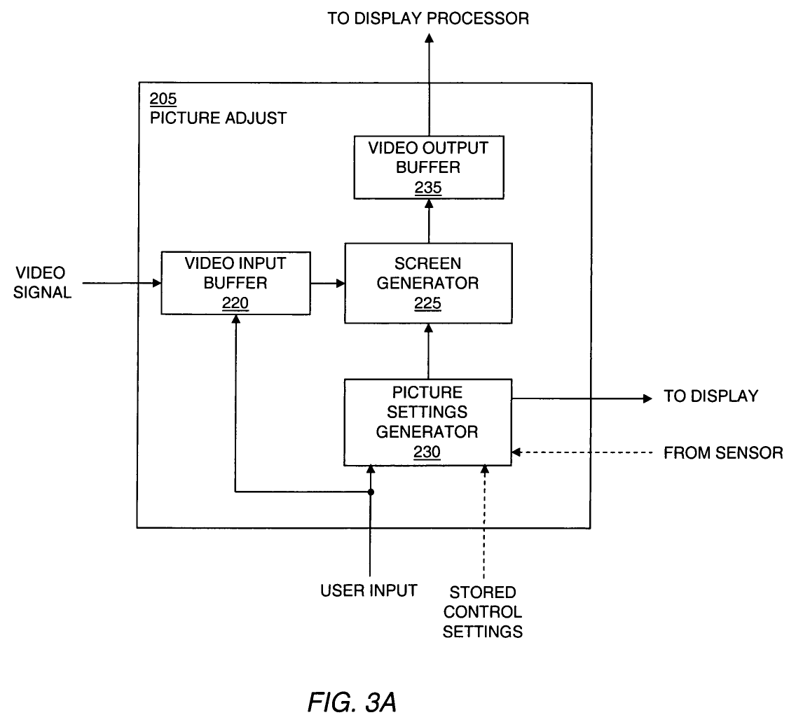

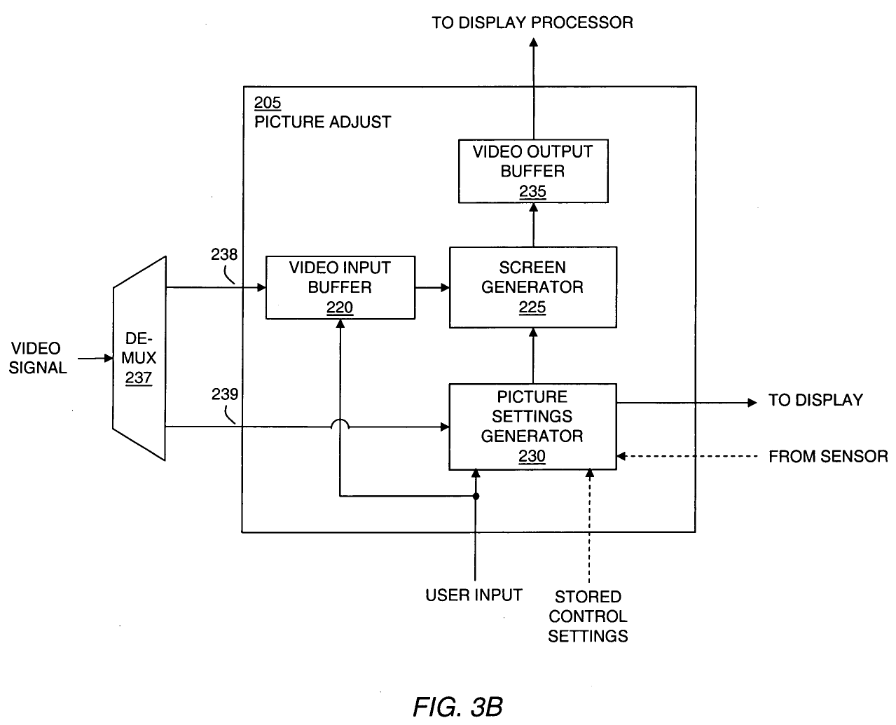

FIG. 3A shows in more detail a schematic block diagram of the picture-adjust module 205. The picture-adjust module 205 includes a video input buffer 220, a on-screen display generator 225, a picture control settings generator 230, and a video output buffer 235. The video input buffer 220 receives an input video signal from the video receiving subsystem 105 and temporarily stores the received video signal for processing by the picture-adjust module 205. For example, the video input buffer 220 includes a frame buffer temporarily storing individual frames of the received video image. If an end user prefers to conduct the image-adjust procedure using a still image rather than motion video, a sample of the received video signal is stored in the video input buffer 220. The picture control settings generator 230 receives a user input from the controller 155 to enter a display-setting mode, and in response generates a group of two or more different picture control settings. In some embodiments, the picture control settings generator 230 also receives a sensor input signal (shown in phantom).

Each of the different picture control settings includes a respective value for each of the available picture parameters or control variables. An exemplary group of three different picture control settings is illustrated below in Table I. The table provides a different column for each of the picture control variables (e.g., brightness, contrast, color, tint, and sharpness). By way of example, each of the exemplary picture control settings differs from the others only in the value of the brightness control variable. Values of each of the different picture control variables are shown as a percentage indicating a percentage of their respective full-range values. In some embodiments the picture control settings include absolute values rather than percentages.

TABLE I
Exemplary Picture Control Settings

| Setting No. | Brightness | Contrast | Color | Tint | Sharpness |
|---|---|---|---|---|---|
| 1 | 60% | 50% | 50% | 50% | 50% |
| 2 | 50% | 50% | 50% | 50% | 50% |
| 3 | 40% | 50% | 50% | 50% | 50% |

The on-screen display generator 225 produces an on-screen display image, sometimes referred to as a comparison image, including three image cells for the exemplary group of three different picture control settings. Each cell includes a representation of the received video image so that all three cells can be displayed at the same time in the same on-screen display image. Each image cell is displayed with the picture tuned according to a respective one of the three different picture control settings of Table I. Thus, each of the three image cells includes the same image with varying degrees of brightness. The video output buffer temporarily stores the comparison image providing it as an output to the display processor 150.

In some embodiments, the picture adjust module 205 receives additional information related to the received video signal. This additional information can include one or more of sensor information, as described above, and program information related to a particular program. For example, the program information can be received from a separate program service, such as a TV GUIDE® service or separate channel providing program-related information. Alternatively, or in addition, program information can be included as extra information together with the received video signal itself. The extra information can be included in a channel subcarrier signal, such as closed captioning, or within a second audio program (SAP) subcarrier.

Alternatively, or in addition, program information can be included with the video signal as metatdata. Analog and digital broadcasts typically have metadata describing the type of program (e.g., news, movie, etc.). The TV set 100 (FIG. 1) extracts the metadata from the broadcast signal. The metadata may be provided through an extended data service, such as one or more of the Extended Data Service (XDS) of EIA-608B specification, the Program and System Information Protocol (PSIP), and a third party provider. Both XDS and PSIP provide data transmitted along with a station's digital TV signal providing digital TV receivers with information about the station and what is being broadcast. This information can be used to identify among other things the genre of a given program and in some instances scene information.

Referring to FIG. 3B, a demultiplexer 237 is provided to extract the extra information from the received video signal. The demultiplexer 237 can be provided within the video receiving subsystem 105 (FIG. 2A and FIG. 2B), within the picture adjust module 205, or as an independent component. The demultiplexer 237 is provided according to the particular form of the extra information. The result is a separation of the video signal and the related extra or metadata.

As an example of how such metadata can be used, program information provided within the metadata indicative of the genre of the program is extracted from the video signal by the demultiplexer 237 and forwarded to a metadata input port 239 of the picture adjust module 205. The picture control settings generator 230 receives program information and uses it to tailor the different picture control settings according to the genre of the program. Some examples of different genre include: movies, sports, concerts, video games, animation, news, historical subject matter, and the like.

Upon entering the display-setting mode, the picture control settings generator 230 uses genre information, when available, to generate the different picture control settings to produce enhanced viewing according to the identified genre. For example, the picture control settings generator 230 generates picture control settings having enhanced green colors in response to a sports genre. The same picture control settings generator 230 generates picture control settings having enhanced brown and/or red colors in response to a historical subject matter genre. In response to an animation or video game genre, picture control settings generator 230 generates picture control settings having enhanced color saturation. Other program control settings can be adjusted independently and in combination, depending upon the one or more algorithms used in the display-setting mode to present the end user with enhanced viewing conditions.

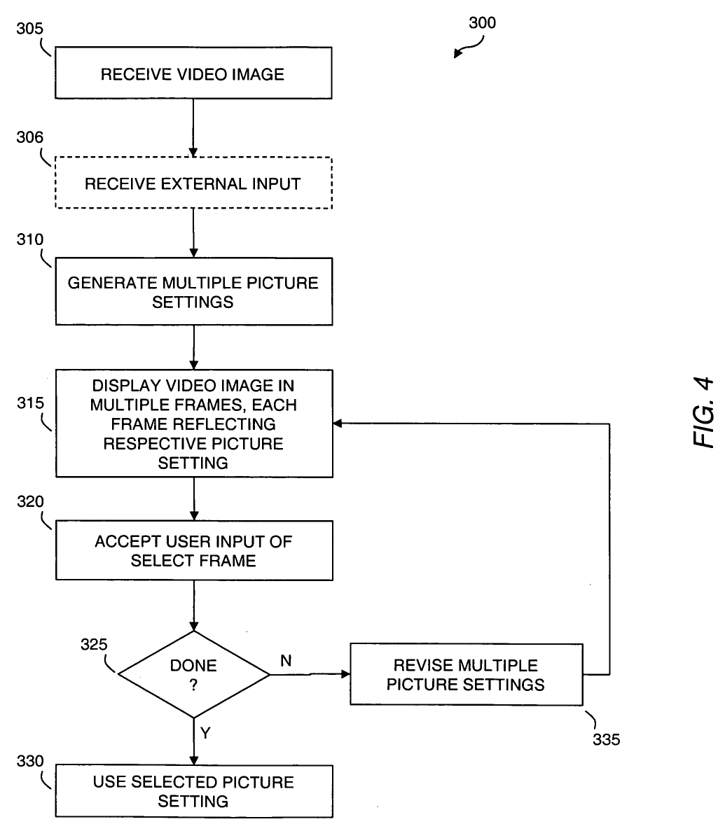

FIG. 4 shows a flow diagram illustrating the steps of the picture-adjust process 300 according to one embodiment of the invention. A video image is received by the picture-adjust module 205 at Step 305. In some embodiments, an external sensor input is received at step 306. Upon entry into the display-setting mode, the picture control settings generator 230 generates multiple different picture control settings at Step 310. When an external sensor input signal is received, it can be used by the picture control settings generator 230 to generate the multiple different control settings. The on-screen display generator 225 receives the video image from the video input buffer 220 and the multiple different picture control settings from the picture control settings generator 230. The on-screen display generator 225 generates an on-screen display image including multiple image cells. Each of the multiple pictures or image cells includes a representation of the received video image tuned or adjusted to a respective one of the different picture control settings. The on-screen display image is forwarded to the display processor 150 (by way of the video output buffer 235) for display upon the display screen 115 at Step 315. An end user observes a visual reproduction of the on-screen display image on the display screen 115, thereby facilitating a comparison of the different image cells and selection of a preferred one of the multiple image cells at Step 320.

If the end user is not yet satisfied with the displayed video image using the current picture control settings, the end user enters a command at Step 325 via the user interface 160 indicating that the picture-adjust procedure should continue. The picture control settings generator 230 generates a different group of picture control settings at Step 335. The different group of picture control settings can be a revised group according to one or more algorithms based on a previous selection. As discussed in more detail below, the revised group picture control settings is generated in response to the particular image cell previously selected by the end user.

A new on-screen display image using the revised group of multiple different picture control settings is generated and displayed at Step 315. In some embodiments, this process continues until the end user is satisfied with the displayed quality of the video image. Thus, the end-user can enter a command via the user interface 160 indicating that the picture-adjust procedure is completed at Step 325 and signaling a return to a normal viewing mode. The picture control settings generator 230 forwards the picture control setting associated with the selected image cell to the display processor 150 and display screen 115 at Step 330. The resulting picture control setting can be used to adjust the one or more picture control variables for viewing all subsequent video images during normal viewing mode operations (i.e., providing the new default picture setting).

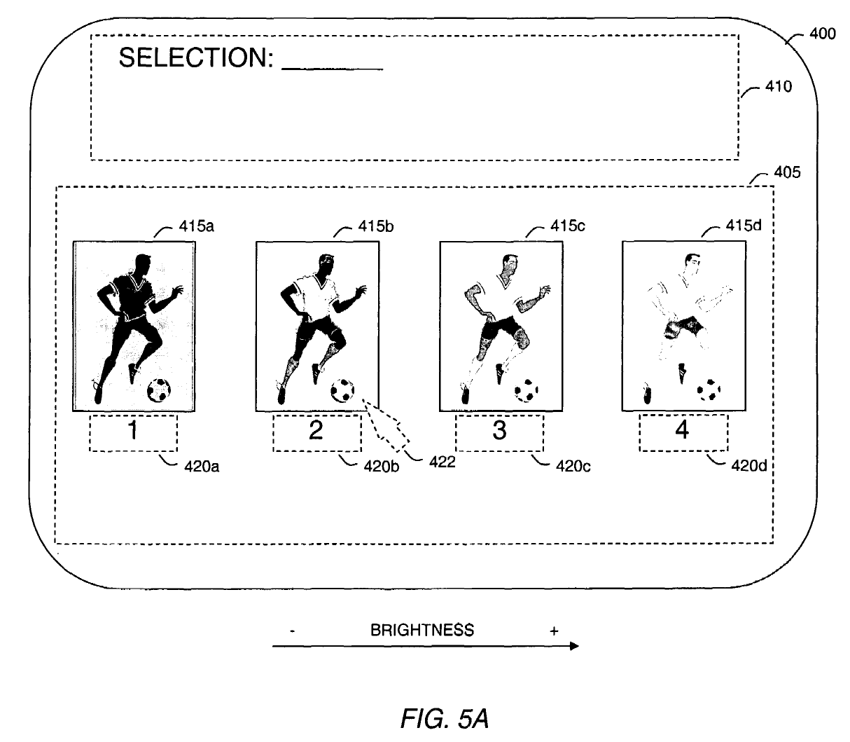

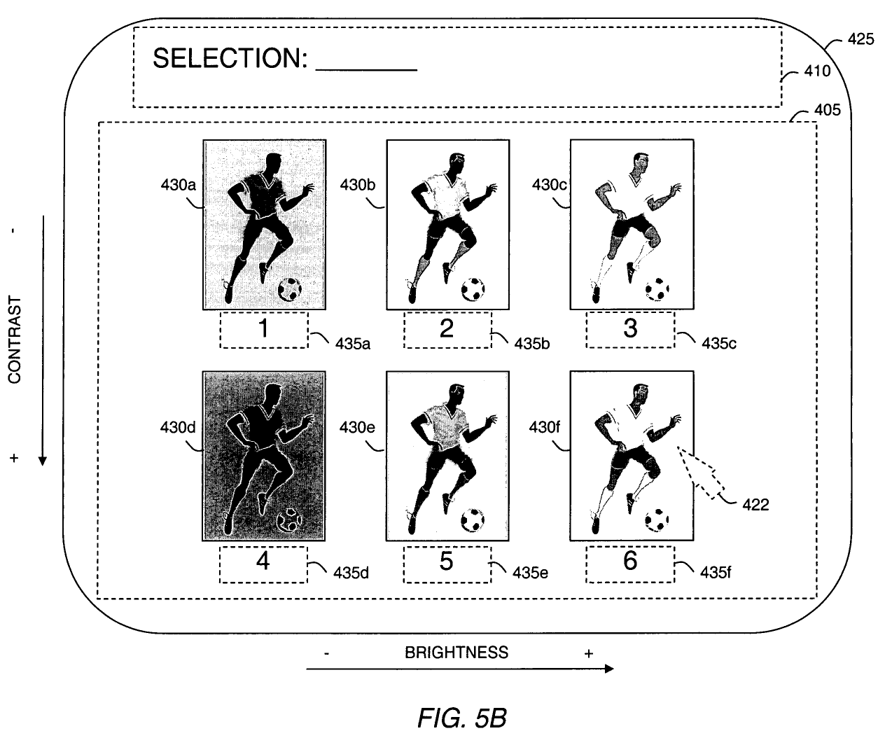

FIG. 5A shows a graphical representation of one embodiment of an exemplary on-screen display, or comparison, image 400 as displayed on the display screen 115. The comparison image 400 includes a graphics field 405 including four different image cells 415a, 415b, 415c, 415d (generally 415), displayed side by side. Each of the different image cells 415 includes a representation of the received video image displayed using a respective one of the different display settings. Due to the reduced size of the image cell and the available pixel resolution, the image cells will typically have a reduced resolution. The video image displayed with the image cells 415 can be motion video, or a still video image (e.g., an individual frame of a video input). In this example, each black-and-white image is displayed with a different brightness control setting (similar to those provided in Table I). In some embodiments, each of the images is distinguished by a respective label 420a, 420b, 420c, 420d (generally 420). For example, the labels 420 can include a reference cell number as shown. In some embodiments, the label 420 also includes information describing the associated picture control setting. For example, the label 420 includes “More Brightness” for one cell and “Less Brightness” for another cell to notify the end-user of the particular parameter being adjusted.

In some embodiments, the comparison image 400 also includes a text field 410 providing instructions and related information to the end user. Alternatively or in addition, user instructions can be provided using audio prompts. As shown, the text field 410 can include a prompt for an end user to enter a selected one of the multiple image cells 415. Such an entry can be made by entry through the user interface 160 of the reference number in the associated label 420. Alternatively, or in addition, the user interface includes a graphical user interface that provides a cursor 422 that can be manipulated through the user interface 160 to select in a point-and-click manner one of the multiple image cells 415.

FIG. 5B shows a graphical representation of an alternative embodiment of a different exemplary comparison image 425 displayed on the display screen 115. The comparison image 425 includes a graphics field 405 including six different image cells 430a through 430f (generally 430), displayed in a two-dimensional rectangular grid, with each image cell 430 including a respective label 435a through 435f. Again, each of the image cells 430 includes a representation of a representation of the received video image displayed using a respective one of the different display control settings. In this example, the image cells represent a first picture control variable (e.g., brightness) varying from left to right, and a second picture control variable (e.g., contrast) varying from top to bottom.

The resulting array of image cells 430 illustrates that an increase in brightness from the first image cell 430a to the second image cell 430b can be at least partially negated by an increase in contrast represented from the second image cell 430b to the fifth image cell 430e (note similarities in appearance between the first and fifth image cells). By providing on a single comparison image 425 multiple image cells 430 varying contrast and brightness, an end user can better perceive subtle differences between different combinations of the different picture control the picture control settings.

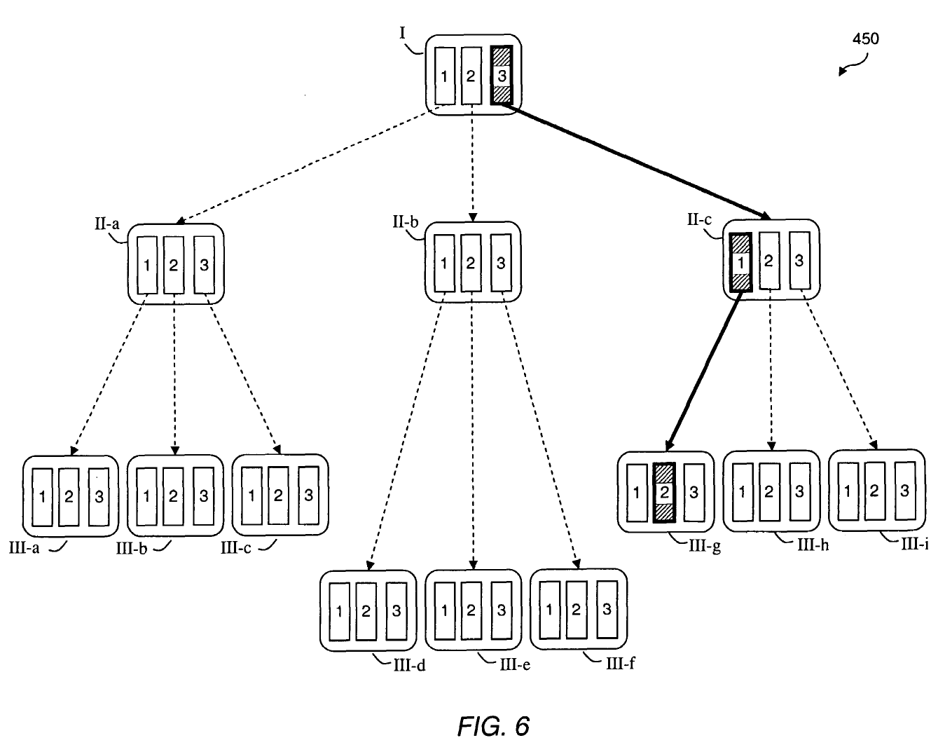

FIG. 6 graphically illustrates the interrelation of different possible on-screen display (OSD) images in a tree format 450. The exemplary OSD images are arranged in three tiers labeled I, II, and III. Each of the OSD images includes three image cells, each providing a representation of the same video image according to a respective picture control setting. Thus, upon entry into the display-setting mode, the on-screen display generator 225 (FIG. 3) generates a first-tier OSD image, referred to as comparison screen I including three image cells 1, 2, and 3. Depending upon which one of the three image cells is selected by the user, a respective one of the second-tier comparison screens II-a, II-b, II-c is displayed. The on-screen display generator 225 generates the appropriate second-tier OSD image in response to the selected one of the first-tier image cells. For example, selection of image cell 3 from comparison screen I results in display of comparison screen II-c.

Similarly, depending upon which one of the three image cells is selected, one of the third-tier comparison screens III-a through III-g is displayed. Once again, the on-screen display generator 225 generates the appropriate third-tier OSD image in response to the selected one of the second-tier image cells. Continuing with the example, selection of image cell 1 of comparison screen II-c results in display of comparison screen III-g. The process continues until a final tier is reached, or until an end user chooses to terminate the process. More generally, the exemplary OSD images can continue to any number of tiers, with each of the output images providing an arbitrary and even variable number of image cells.

The picture control settings can be generated according to a predetermined algorithm. For example, an algorithm can initially establish an end user's preference of one or more picture controls (e.g., brightness and contrast) before adjusting other picture controls (e.g., color and tint). Thus, the end user is presented with a first-tier comparison image that varies the brightness and contrast. The second-tier can vary the same parameters to a finer resolution, or commence varying other parameters. Alternatively, or in addition, one or more different algorithms can be used, such as a first algorithm providing coarse adjustments, and a second algorithm providing finer adjustments. In some embodiments, an initial comparison screen provides variation in several of the parameters, to establish an end user's preference as to which parameters should be adjusted first.

As described above, picture control variables provided by manufacturers can include brightness, contrast, color, tint, and sharpness. Depending upon the display technology, there can be other device-specific settings available, such as individual adjustments of white and black levels. Alternatively or in addition, rather than simply using color and tint adjustments in RGB color space, other picture control variables, different than those provided by the display manufacturer, such as different color spaces can be used to provide enhanced variability (e.g., using a computer monitor YUV color space to adjust a TV display). Any of the picture control variables such as color space can be changed during the course of a single picture-adjust setting procedure providing the end user with a much wider variability in picture control settings, without unnecessarily overwhelming or confusing the end user with numerous and varied terms. Even abstract picture controls, such as color temperature can be used during the picture-adjust setting procedure. In some embodiments, one set of picture control variables is used to generate picture control settings displayed in a first comparison image, while a second, different set of picture control variables is used to generate picture control settings for a subsequent comparison image.

In some embodiments, adjustment of the different picture control settings and conversions between different color spaces are performed within the picture-adjust module 205 (FIG. 2). Regardless of the complexity in the adjustment of any picture control variables, the end user is simply presented with multiple image cells from which to make a simple comparative selection.

With the added flexibility in adjusting picture controls, an end user can choose to make adjustments that were heretofore not possible. Such adjustments include adjustment of one or more of individual colors. For example, an end user can select to provide an offset to one or more of the colors, such as a shift in all of the blue colors (more blue) without shifting either the red or the green.

While the invention has been shown and described with reference to specific preferred embodiments, it should be understood by those skilled in the art that various changes in form and detail can be made therein without departing from the spirit and scope of the invention as defined by the following claims.

What is claimed is:

1. A method of optimizing presentation of an image on a display device equipped with at least one adjustable picture control variable, comprising:
receiving an image-bearing signal;
determining a first plurality of picture control settings, each representing a different configuration of the at least one adjustable picture control variable;
generating an on-screen display image having a plurality of image cells, each image cell displaying a representation of the received image-bearing signal tuned according to a respective one of the first plurality of picture control settings;
accepting a user selection of a preferred one of the plurality of image cells; and
adjusting the at least one adjustable picture control variable to the picture control setting of the preferred one of the plurality of image cells.

2. The method of claim 1, wherein the steps of generating an on-screen display image and accepting a user selection comprise:
generating a first on-screen display image having a first plurality of image cells, each image cell displaying a representation of the received image-bearing signal tuned according to a respective one of the first plurality of picture control settings;
accepting a user selection of a preferred one of the first plurality of image cells;
determining a second plurality of picture control settings in response to the accepted user selection;
generating a second on-screen display image having a second plurality of image cells, each image cell displaying a representation of the received image-bearing signal tuned according to a respective one of the second plurality of picture control settings; and
accepting a user selection of a preferred one of the second plurality of image cells.

3. The method of claim 2, wherein the second plurality of picture control settings converges toward a user-preferred picture setting based on the preferred one of the first plurality of image cells.

4. The method of claim 1, wherein receiving the image-bearing signal comprises receiving a video signal.

5. The method of claim 4, wherein the video signal is a digital video signal.

6. The method of claim 1, wherein the at least one adjustable picture control variable is selected from the group consisting of: contrast; contrast ratio; white level; brightness; luminance; black level; gray scale; sharpness; detail; chrominance; color; tint; hue; saturation; individual color level; geometry; gamma; and backlight level.

7. The method of claim 1, wherein the on-screen display image includes a respective reference indicator associated with each of the plurality of image cells, acceptance of the user selection comprising acceptance of the respective reference indicator.

8. The method of claim 1, wherein determining the picture control settings comprises using a plurality of preset picture control settings.

9. The method of claim 1, further comprising the step of receiving a sensor signal, wherein the first plurality of picture control settings are determined responsive to the received sensor signal.

10. The method of claim 9, wherein the sensor signal is indicative of ambient lighting.

11. The method of claim 9, wherein the sensor signal is indicative of the received image-bearing signal.

12. The method of claim 9, wherein the step of receiving the sensor signal comprises extracting metadata from the received image-bearing signal.

13. An apparatus for optimizing presentation of an image-bearing signal on a display device equipped with at least one adjustable picture control variable, comprising:
a processor configured to receive the image-bearing signal, the processor having:
a picture control setting generator configured to determine a plurality of picture control settings each representing a different configuration of the at least one adjustable picture control variable; and
an on-screen display generator configured to generate a first on-screen display image having a plurality of image cells, each image cell displaying a representation of the received image-bearing signal tuned according to a respective one of the plurality of picture control settings;
a memory in communication with the processor and configured to store at least one of the plurality of picture control settings; and
a display device in communication with the processor configured to display the first on-screen display.

14. The apparatus of claim 13, further comprising a user interface in communication with the processor and configured to accept a user selection of a preferred one of the plurality of image cells.

15. The apparatus of claim 13, wherein the received image-bearing signal comprises a video signal.

16. The apparatus of claim 15, wherein the video signal is a digital video signal.

17. The apparatus of claim 15, wherein the video signal is a motion video signal, each image cell displaying a representation of the motion video signal.

18. The apparatus of claim 13, wherein the at least one adjustable picture control variable is selected from the group consisting of: contrast; contrast ratio; white level; brightness; luminance; black level; gray scale; sharpness; detail; chrominance; color; tint; hue; saturation; individual color level; geometry; gamma; and backlight level.

19. The apparatus of claim 13, further comprising a sensor coupled to the processor, the picture control setting generator receiving a sensor signal from the sensor and determining the plurality of picture control settings in response to the received sensor signal.

20. The apparatus of claim 19, wherein the sensor is a light sensor providing a sensor signal indicative of ambient lighting.

21. The apparatus of claim 19, wherein the sensor is a metadata receiver providing a metadata signal indicative of content of the received image-bearing signal.

22. An apparatus for optimizing presentation of an image-bearing signal on a display device equipped with at least one adjustable picture control variable, comprising:
means for receiving the image-bearing signal;
means for automatically determining a plurality of picture control settings, each representing a different configuration of the at least one adjustable picture control variable;
means for generating an on-screen display image having a plurality of image cells, each image cell displaying a representation of the received image-bearing signal tuned according to a respective one of the plurality of picture control settings; and
means for accepting a user selection of a preferred one of the plurality of image cells.

23. A method of optimizing presentation of an image-bearing signal on a display device equipped with at least one adjustable picture control variable, comprising:
receiving a sensor signal;
determining a first plurality of picture control settings, each representing a different configuration of the adjustable picture control variables responsive at least in part to the received sensor input signal;
generating a first on-screen display image having a first plurality of image cells, each image cell displaying a representation of the image- bearing signal tuned according to a respective one of the first plurality of picture control settings; and
accepting a user selection of a preferred one of the first plurality of image cells.

24. The method of claim 23, wherein the sensor signal is indicative of ambient lighting.

25. The method of claim 23, wherein the sensor signal is indicative of the received image-bearing signal.

26. The method of claim 23, wherein the step of receiving the sensor signal comprises extracting metadata from the image-bearing signal.

27. A method of interactively guiding a viewer through configuration of adjustable picture control variables in order to obtain a desired presentation of images on a display screen of a display device, the method comprising:
displaying a first portion of an image in a first region of the display screen in accordance with a first picture control setting of an adjustable picture control variable; and
displaying a second portion of the image in a second region of the display screen in accordance with a second picture control setting of the adjustable picture control variable, the second region of the display screen being adjacent to the first region to facilitate a comparison by the viewer of the first image portion with the second image portion.

28. The method of claim 27, further comprising the steps of:
receiving a signal indicating a selection by the viewer of one of the first and second image portions; and
displaying a second image on the display screen based on the viewer selection.

29. The method of claim 28, wherein the step of displaying the second image on the display screen includes displaying, in accordance with a first picture control setting of a second adjustable picture control variable, a new first portion of the second image in the first region of the display screen, and displaying, in accordance with a second picture control setting of the second adjustable picture control variable, a new second portion of the second image in the second region of the display screen adjacent to the first region to facilitate a comparison by the viewer of the new first image portion with the new second image portion.

30. The method of claim 27, wherein the first image portion and the second image portion are representations of a same video image.

31. An apparatus for interactively guiding a viewer through configuration of adjustable picture control variables in order to obtain a desired presentation of images on a display screen of a display device, the apparatus comprising:
a processor including a picture control setting generator configured to determine a plurality of picture control settings and an on-screen display generator configured to generate an on-screen display image having first and second image portions, each picture control setting representing a different configuration of an adjustable picture control variable, each image portion being displayed in accordance with a different one of the plurality of picture control settings; and
a display device in communication with the processor, the display device being configured to display the first image portion in a first region of the display screen and the second image portion in a second region of the display screen adjacent to the first region to facilitate a comparison by a viewer of the first image portion with the second image portion.

32. The apparatus of claim 31, further comprising a controller in communication with the processor, the controller receiving a signal indicating a selection by the viewer of one of the first and second image portions, wherein the display device displays a second image on the display screen based on the received viewer selection.

33. The apparatus of claim 32, wherein the second image displayed on the display screen includes:
a new first portion displayed in accordance with a first picture control setting of a second adjustable picture control variable in the first region of the display screen; and
a new second image portion of the second image displayed in accordance with a second picture control setting of the second adjustable picture control variable in the second region of the display screen adjacent to the first region to facilitate a comparison by the viewer of the new first image portion with the new second image portion.
